(19) United States
(12) Patent Application Publication
(10) Pub. No.: US 2015/0346981 A1
(43) Pub. Date: Dec. 3, 2015

(54) SLIDER CONTROLLING VISIBILITY OF OBJECTS IN A 3D SPACE

(71) Applicant: Apple Inc., Cupertino, CA (US)

(72) Inventors: Godwin Johnson, Cupertino, CA (US); Maxwell O. Drukman, Cupertino, CA (US)

(73) Assignee: Apple Inc., Cupertino, CA (US)

(21) Appl. No.: 14/291,838

(22) Filed: May 30, 2014

(51) Int. Cl. G06F 3/0484; G06F 3/0482; G06F 3/0489; G06F 3/0481

(52) U.S. Cl. CPC G06F 3/04847; G06F 3/04817; G06F 3/04842; G06F 3/0482; G06F 3/04897; G06F 2203/04806; G06F 2203/04802

(57) ABSTRACT

Systems, apparatus, and methods to control the visibility of objects to be presented in a three-dimensional space on a display. Embodiments include a slider having a pair of controls that may be independently manipulated and positioned. The slider oriented in a plane perpendicular to a plurality of parallel planes that include a plurality of individual layers, each layer including one or more objects. The individual layers may be hidden or displayed on a graphical user interface in response to the manipulation of either or both of the controls. The plurality of parallel planes may be reoriented in response to the positioning of either or both of the controls. The slider may include a plurality of equidistantly spaced divisions; each division may correspond to an individual layer in the plurality of parallel planes. The spacing between the divisions may be manipulated to change the spacing between the plurality of parallel planes.

### BACKGROUND

The development of applications that present graphical images to a user on a computing device must take into account the form factor of the user interface available on the intended computing device. For example, an application developed for a personal computer equipped with a keyboard, a display monitor, and a pointing device may successfully use graphical elements to present a user interface on the monitor that would be difficult if not impossible to navigate if the graphical elements were presented on a smartphone or tablet computing device with a different display size. Similarly, a laptop or other mobile device equipped with a touch screen may present different human factors that an application developer may consider when developing software applications for one or more devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A through 1D depict a block diagram illustrating an example of a graphical user interface in a two-dimensional control mode, according to an embodiment.

FIGS. 2A through 2E depict a block diagram illustrating an example of a 3D graphical user interface in a three-dimensional control mode, according to an embodiment.

FIG. 3 depicts a block diagram illustrating an example of a graphical user interface in a three-dimensional control mode, according to an embodiment.

FIG. 4 depicts a block diagram illustrating an example of a graphical user interface in a three-dimensional control mode, according to an embodiment.

FIG. 5 is a network diagram depicting a network, according to an embodiment.

FIG. 6 depicts a flow diagram illustrating an example scheme for illustrating operations of a device or apparatus in performing methods of manipulating a three-dimensional display, according to an embodiment.

FIG. 7 depicts a flow diagram illustrating an example scheme for illustrating operations of a device or apparatus in performing methods of manipulating a three-dimensional display, according to an embodiment.

FIG. 8 depicts a flow diagram illustrating an example scheme for illustrating operations of a device or apparatus in performing methods of manipulating a three-dimensional display, according to an embodiment.

FIG. 9 is a block diagram illustrating an example machine upon which any one or more of the techniques discussed herein may be performed.

FIGS. 10A through 10D depict block diagrams illustrating four different views of an example of a graphical user interface (GUI) 1000 in a three-dimensional control mode, according to an embodiment.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

User interface development tools may provide an application developer with the ability to assemble a variety of different views or screens of information to a user. An individual view may include a variety of different objects or elements, some of which may be layered or stacked on top of (or in front of) each other in completely or partially overlapping configurations. The management, organization, and manipulation, of different views and their constituent objects or elements may become cumbersome to manipulate if the design of a view includes more than a small number of elements. Additionally, interacting with multiple objects that are distributed among overlapping layers may not be intuitive when presented in a two-dimensional interface.

An application's user interface may be built from a hierarchy of view objects. For example, a root object for a view can have members indicating the position and dimensions of the view. The root object can also have a list of child objects appearing in the view. The child objects can also have positions, dimensions, and further child objects.

The hierarchy of view objects can be displayed as a three-dimensional representation of the view. For example, a set of layers can be created, with each layer corresponding to a level in the hierarchy of view objects. The rear-most layer can represent the view object, the next layer forward can represent objects that are directly referenced by the view object, the layer in front of that can represent the child objects of the directly-referenced objects, and so on.

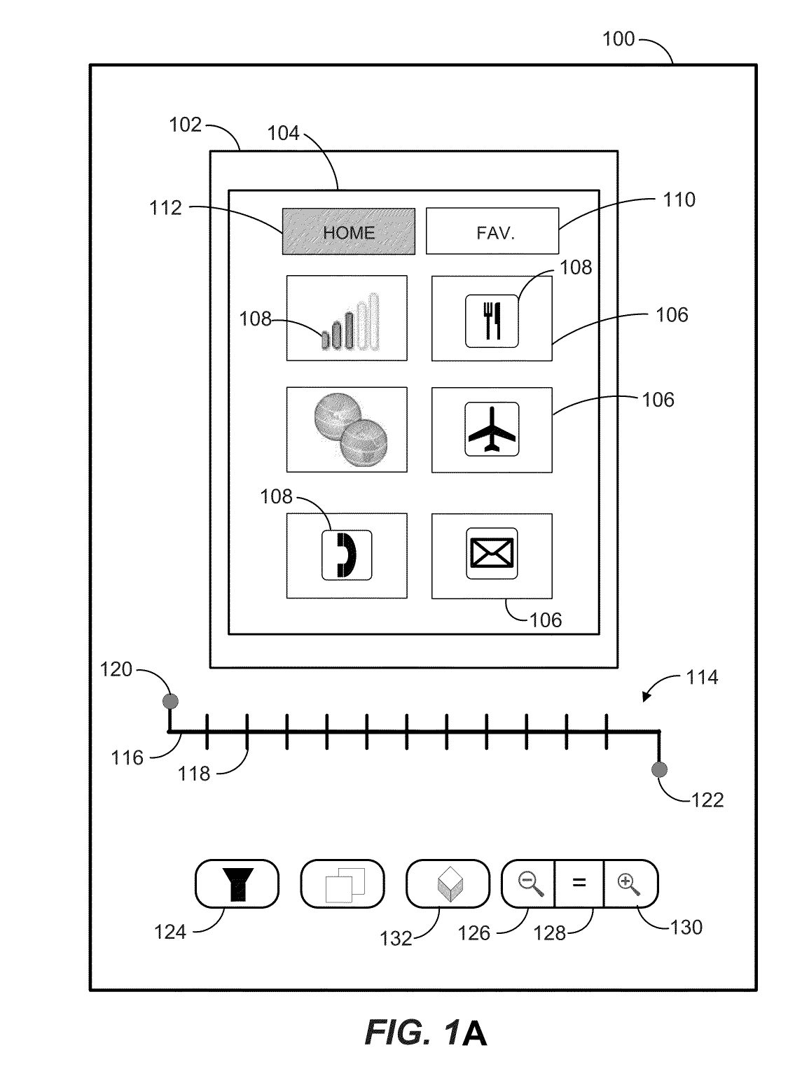

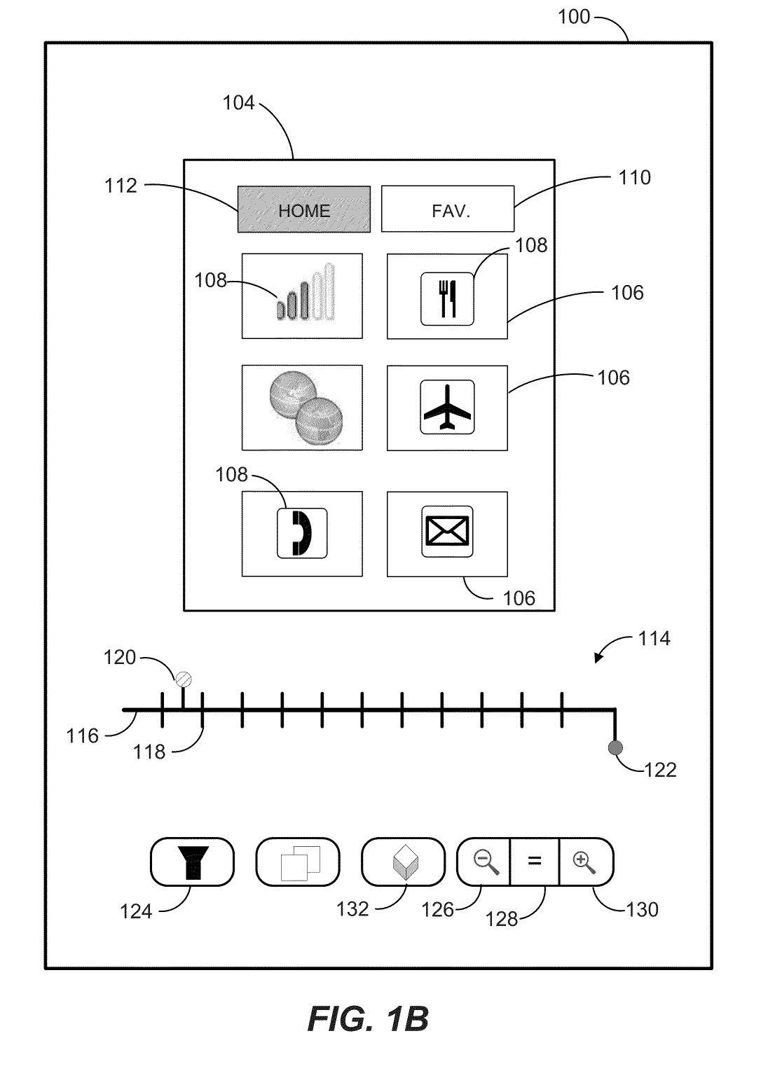

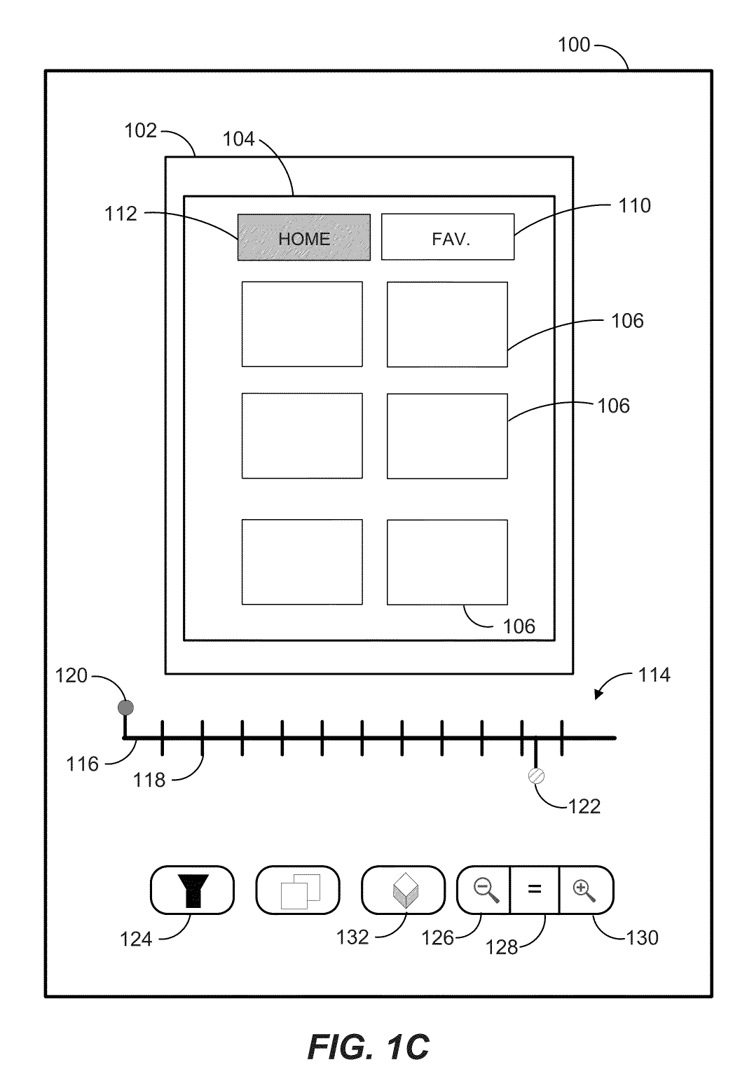

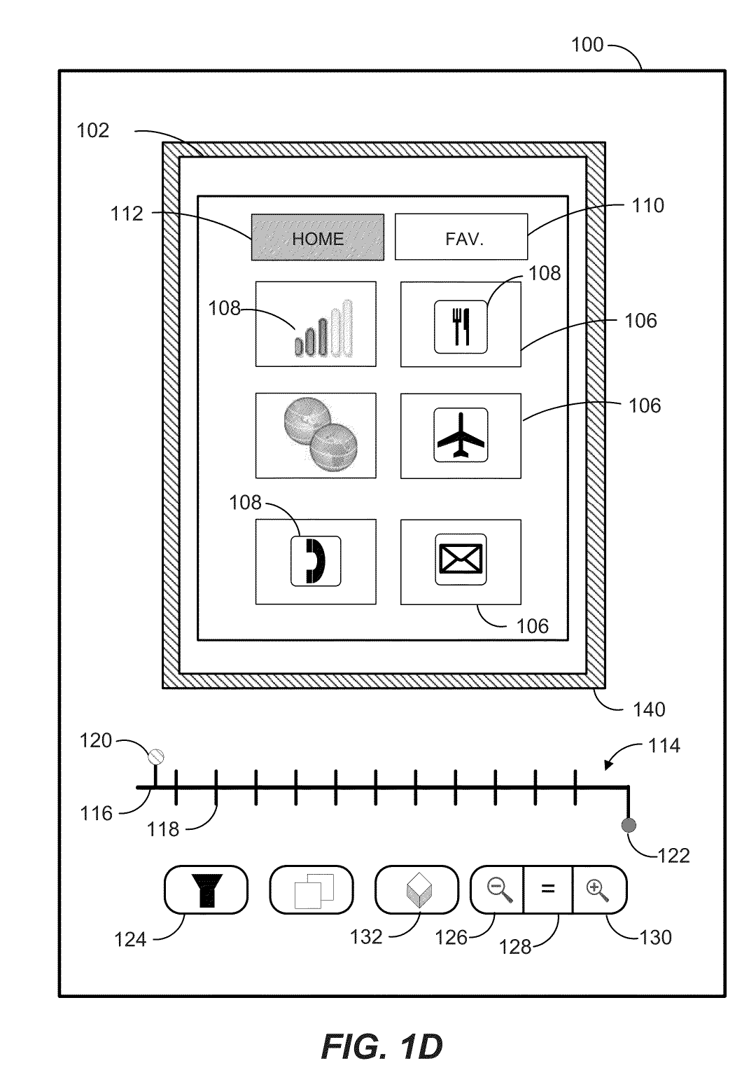

FIGS. 1A through 1D depict a block diagram illustrating an example of a graphical user interface 100 in a two-dimensional control mode. The graphical user interface 100 presents a canvas where objects may be inspected, edited, or assembled in separate layers in order to construct a graphical application targeted at one or more computing devices. For example, a background object 102 that may be sized to fill the canvas when the canvas matches a display size of a specific computing device. For example, the background object may be sized to correspond to a 1136-by-640 pixel resolution display device of a target computing device. The background may be smaller than the 1136-by-640 pixel resolution display device of a target computing device if the background object 102 is configured to only require a portion of the entire display of the target computing device. Alternative resolutions may correspond to any available or commonly used computing display (e.g., 320-by-480, 960-by-640, 1024-by-768, or 1920-by-1080 pixels), or range from one-by-one individual pixel objects to expansive display sizes that are limited only by the available physical computing resources of an individual device.

A second object 104 may be placed in front of, or on top of, the back ground object. The second object 104 may be visually distinct from the background object 102 such that a boarder appears to surround the second object 104. The second object 104 may include, or be disposed behind, any of a variety of other objects such as buttons 106. Buttons 106 may include icons 108 that indicate a function or action that may be taken when one of the buttons 106 is selected. Navigation selectors such as a favorites menu 110 or a home menu 112 may be included in a layer parallel to the buttons 106. The background object 102, second object 104, buttons 106, and icons 108, may all be disposed in separate layers. In this manner each layer, and the objects disposed in an individual layer, may be manipulated independently of the other layers.

The graphical user interface 100 includes a slider 114 that may control the visibility of objects in each layer of the canvas. The slider 114 includes a slider axis 116, a plurality of divisions 118. The divisions 118 may correspond to individual layers on the canvas, or be proportionally distributed along the slider axis 116 independent of the number of individual layers. In an example, the number of divisions 118 along the slider axis 116 may change, e.g., increase or decrease, as layers are added or removed from the canvas.

The slider 114 includes a first control 120 and a second control 122 that may be manipulated independently of each other. The first control 120 and the second control 122 may include an indicator, such as an icon or colored blub, which may change appearance when one or both of the controls (120, 122) is selected. The first control 120 may initially be disposed at one end of the slider axis 116 and the second control 122 may be disposed at an end of the slider opposite the first control 120. The first control 120 or the second control 122 may be manipulated, e.g., moved along the slider axis 116, to display, hide, or highlight one or more of the layers on the canvas. For example, as the first control 120 or the second control 122 is moved along the slider axis 116 an individual layer corresponding to the position of the first control 120 or the second control 122 may be highlighted. Individual objects in the highlighted layer may be selected by a user selection input.

The graphical user interface 100 may include additional tools to manipulate the layers and the graphical user interface 100. For example, a filter tool 124 may be presented, which when selected or tapped causes a dialog to be presented on or near the graphical user interface 100, to provide a mechanism to limit or select the layers to be displayed or hidden from view on the canvas. A zoom-out tool 126, a normal view tool 128, and a zoom-in tool 130 may be presented by the graphical user interface 100. When selected, the zoom-out tool 126 and the zoom-in tool 130 may change the size of, e.g., shrink or enlarge, respectively, the objects on the canvas. The normal view tool 128 may be selected to return the objects on the canvas to a preset view, such as the actual size or 100% zoom. In an example, the normal view tool 128 can function as a scale-to-fit tool fitting the view to the available display size. A view change tool 132 may be selected to transition the objects displayed on the canvas from a two-dimensional front view to a three-dimensional perspective view. Additional tools may be included to add, remove, import, edit or otherwise modify the content or display of any object in any layer on the canvas within the graphical user interface 100.

In FIG. 1B, the first control 120 is depicted as being selected and disposed at a location past the first of the slider divisions 118. The selection of the first control 120, or any other control in the graphical user interface 100, may be accomplished by receiving an input from a user. The user input may include a touch, swipe or tap on a touch screen display, a left, right or middle button click on a mouse, selection of an object through keyboard strokes, or any other mechanism for receiving a user selection of the object. As a result of the change in position of the first control 120, the background object 102 is no longer displayed. In the example graphical user interface 100 depicted in FIGS. 1A through 1D, the background object 102 is disposed at the back or bottom layer of the canvas. In this manner, each layer in the canvas may be considered as one of a continuum of planes that are parallel to each other.

In FIG. 1C, the second control 122 is depicted as being selected and disposed at a location past the last of the slider divisions 118. As a result of the change in position of the first control, the icons 108 are no longer displayed. In the example graphical user interface 100 depicted in FIGS. 1A through 1D, the icons 108 are disposed at the front or top layer of the canvas. The first control 120 is depicted as being disposed at its original location (depicted in FIG. 1A) on the axis 116. As a result of the change in position of the first control 120, the background object 102 is displayed and again visible in the graphical user interface.

In FIG. 1D, the first control 120 is depicted as being selected and disposed at a location adjacent to the first of the slider divisions 118. As a result of the selection of the first control and the position adjacent to the first of the slider divisions 118, the background object 102 is selected and highlighted by a frame 140. The frame 140 may correspond to the size of a target display device. Any object disposed on the selected frame, but positioned outside of the frame 140 may be highlighted to indicate that the object would not be visible if the layer was displayed on the target display device.

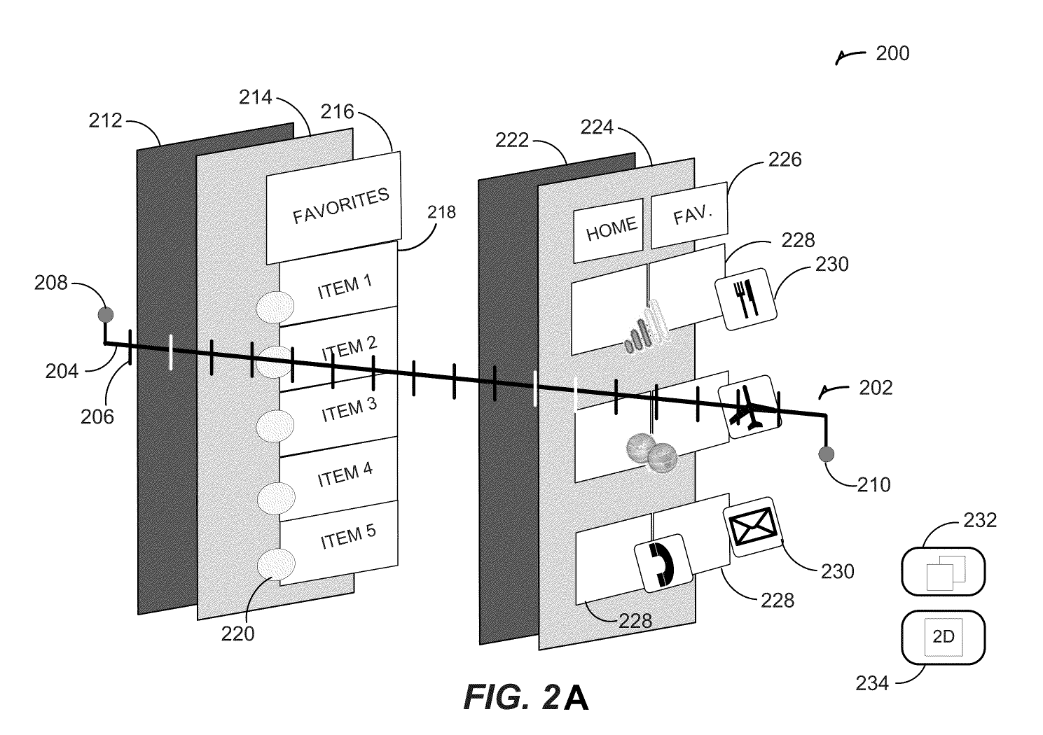

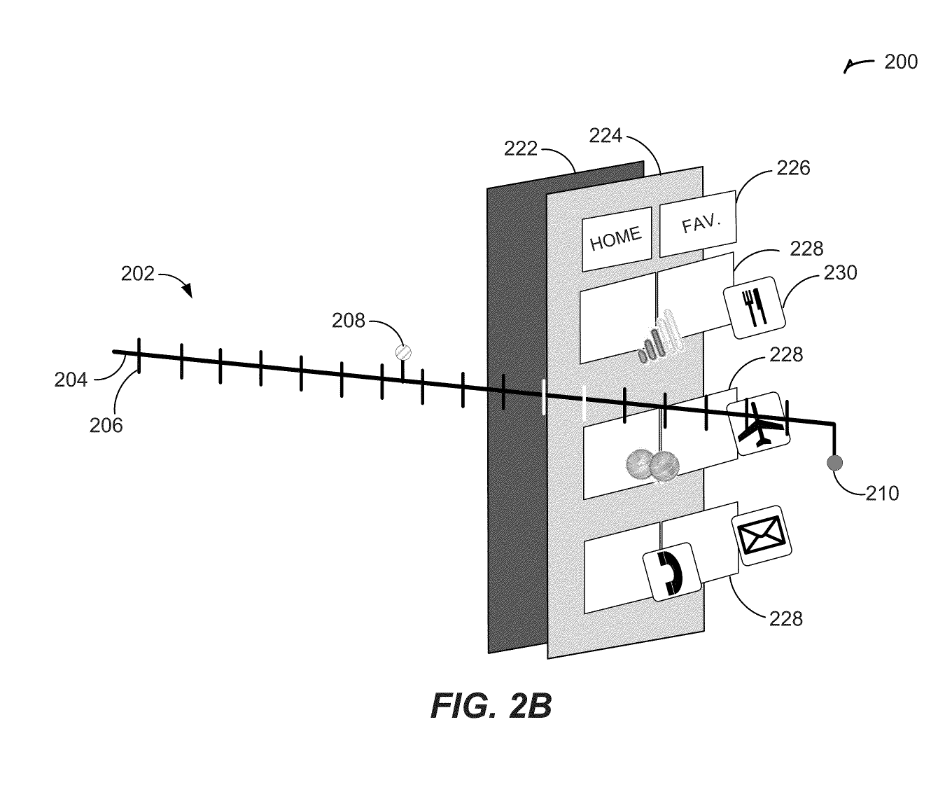

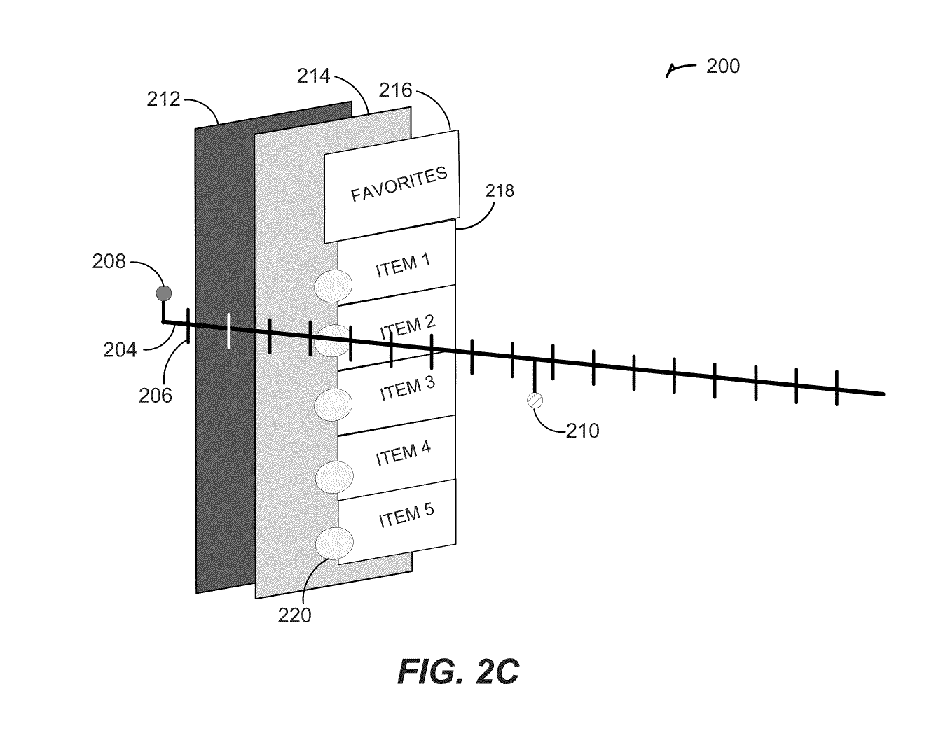

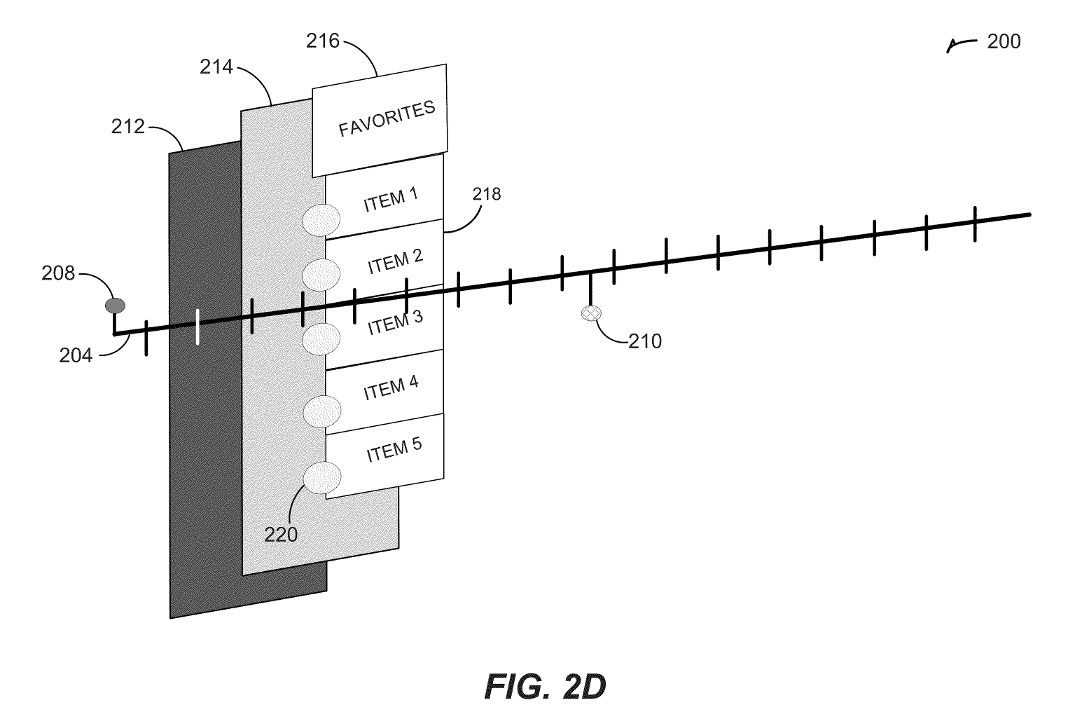

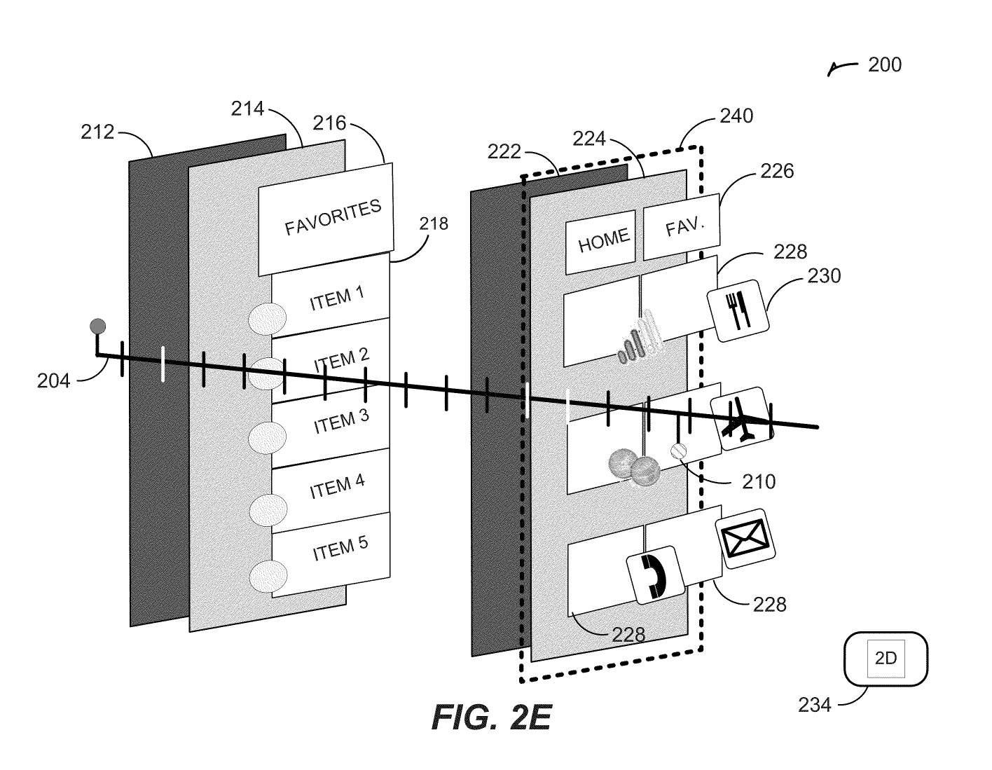

FIGS. 2A through 2E depict a block diagram illustrating an example of a 3D graphical user interface 200 in a three-dimensional control mode. In an example, the three-dimensional control mode may be accessed through the selection of the view change tool 132 as depicted in FIG. 1A. The graphical user interface 200 includes a 3D slider 202 that controls the visibility of objects in each layer of a canvas. The canvas may include all visible area where elements in the 3D graphical user interface 200 are visible. The 3D slider 202 includes a 3D slider axis 204 and a plurality of divisions 206. The divisions 206 may correspond to individual layers on the canvas, or be evenly distributed along the 3D slider axis 204 independent of the number of individual layers. In an example, the number of divisions 206 along the 3D slider axis 204 may change, e.g., increase or decrease, as layers are added or removed from the canvas.

The 3D slider 202 includes a first 3D control 208 and a second control 210 that may be manipulated independently of each other. The first 3D control 208 and the second 3D control 210 may include an indicator, such as an icon or colored circle, sphere or other shape, which may change in appearance when each of the controls (208, 210) is selected, respectively. The selection of the first 3D control 208 and the second 3D control 210 can be achieved through the manipulation of a pointer on a display that is presenting the 3D graphical user interface, or in another example, by receiving a touch input on a touch screen display. The first 3D control 208 may initially be disposed at one end of the 3D slider axis 204, and the second 3D control 210 may initially be disposed at an end of the slider opposite the first 3D control 208.

The first 3D control 208 or the second 3D control 210 may each be independently manipulated, e.g., moved along the 3D slider axis 204, to display, hide, or select one or more of the layers on the canvas. Additionally, the first 3D control 208 or the second 3D control 210 may each be independently positioned on the canvas. When one or both of the first 3D control 208 or the second 3D control 210 are changed each layer on the canvas may be repositioned or reoriented in response to the change in position of the first 3D control 208 or the second 3D control 210. In an example, the 3D slider 202 may stay in alignment with respect to the layers in the canvas. In this manner, the 3D slider 202 remaining aligned with the layers provides for direct manipulation of the objects in the layers, thereby improving a user's ability to manipulate the objects depicted in each layer on the canvas and provide a seamless user experience.

The 3D graphical user interface 200 of FIG. 2A includes a plurality of objects that are disposed on a canvas or work area, and arranged in parallel layers that are perpendicular to the 3D slider axis 204. A first layer 212, in the depicted example, includes a background plane for a favorites menu. The favorites menu may include a foreground color disposed in a second layer 214. On top of, or in front of, the second layer 214 is a third layer that includes a title bar 216 and a plurality of text boxes 218. A fourth layer includes a plurality of buttons 220 that are arranged in line with the plurality of text boxes 218 in the third layer. The plurality of buttons 220 are offset from text boxes 218 by their location in the fourth layer.

A fifth layer 222 includes a background plane for a home menu. The fifth layer 222 may be disposed in front of the first through fourth layers, and optionally, separated by space where additional layers could be inserted. The home menu may include a foreground color in a sixth layer 224. On top of the sixth layer 224 is a seventh layer that includes a menu 226 and a plurality of selection buttons 228. An eighth layer includes a plurality of icons 230 that correspond with each one of the selection buttons 228 and are disposed above, or in front of, the respective selection buttons 228.

The 3D graphical user interface 200 may also include menu items such as a layer spacing tool 232 or a 2D mode selection icon 234. In an example, the selection of the layer spacing tool 232 may arrange each layer in the canvas at an equidistantly spaced arrangement or a default spacing. In an example, the 2D mode selection icon 234 may transition the 3D graphical user interface 200 to a two-dimensional control mode such as the graphical user interface 100 of FIG. 1A. In an example, the selection of the layer spacing tool 232 may highlight the plurality of divisions 206. The selection and translation of one of the divisions 206 changes the spacing between the plurality of divisions 206. For example, a spacing input may equally increase or decrease the distance between each one of the plurality of divisions 206, or increase or decrease the distance between a selected subset of the plurality of divisions 206.

The 3D slider 202 may by continuously oriented in 3D space as the viewing angle of the canvas is changed such that the 3D slider 202 stays closely associated to the objects and layers on the canvas. In this manner convenient user interaction with both the layers, objects and the slider may be maintained. For example, the 3D slider may be automatically positioned at the base of the canvas, as depicted in FIG. 1A a switch between a 3D mode to a 2D mode is initiated.

In FIG. 2B, the first 3D control 208 of the 3D slider 202 is selected, as indicated by a first change in color of the indicator, and disposed between two slider divisions such that the first through fourth layers are hidden from view on the canvas. In this manner any combination of layers, and any objects in the one or more layers, may be displayed on the 3D graphical user interface 200.

In FIG. 2C, the second 3D control 210 of the 3D slider 202 is selected, as indicated by a first change in color of the indicator, and disposed at a location between two slider divisions such that the fifth through eighth layers are hidden from view on the canvas. The first 3D control 208 of the 3D slider 202 is unselected and positioned at its original position at the first end of the 3D slider 202 such that the first through fourth layers are displayed on the canvas. The first 3D control 208 and the second 3D control 210 may be independently positioned at any location along the 3D slider 202 thereby allowing a user to selectively display or hide one or more layers in the canvas.

In an example, the first 3D control 208 and the second 3D control 210 are limited such that their order is maintained such that the first 3D control 208 may not be positioned to the right, or on top of, the second 3D control 208. The first 3D control and the second 3D control may be positioned at immediately adjacent positions such that no objects or layers are displayed.

The first 3D control 208 and the second 3D control 210 may both be selected and then positioned simultaneously, e.g., with a single input. For example, the first 3D control 208 and the second 3D control 210 may be positioned at or between adjacent divisions 206 such that only a single layer of the canvas is displayed. Both the first 3D control 208 and the second 3D control 210 may be positioned along the 3D slider axis 204 of the 3D slider 202 such that each layer is sequentially displayed individually. In this manner each individual layer, and any objects in the layer, may be displayed on the 3D graphical user interface 200.

In FIG. 2D, the second 3D control 210 of the 3D slider 202 is selected, as indicated by a second change in color of the indicator, and positioned, such as a result of receiving a positioning input via an input device, at a location above its previous location as depicted in FIG. 2C. In response to the repositioning of the second 3D control 210, the 3D slider axis 204 are reoriented to a new angle and the objects in the first through fourth layers (212, 214, 216, 218, 220) are reoriented to a new configuration. In this manner the 3D slider 202 and any displayed objects may be reoriented in response to positioning inputs to provide multiple viewing angles of the objects. In an example, the sequential or hierarchical relationship of the layers to each other may be maintained regardless of the orientation of the 3D slider 202. In this manner the scope of control provided by the 3D slider 202 changes dynamically as the visibility of the objects on the canvas changes. For example

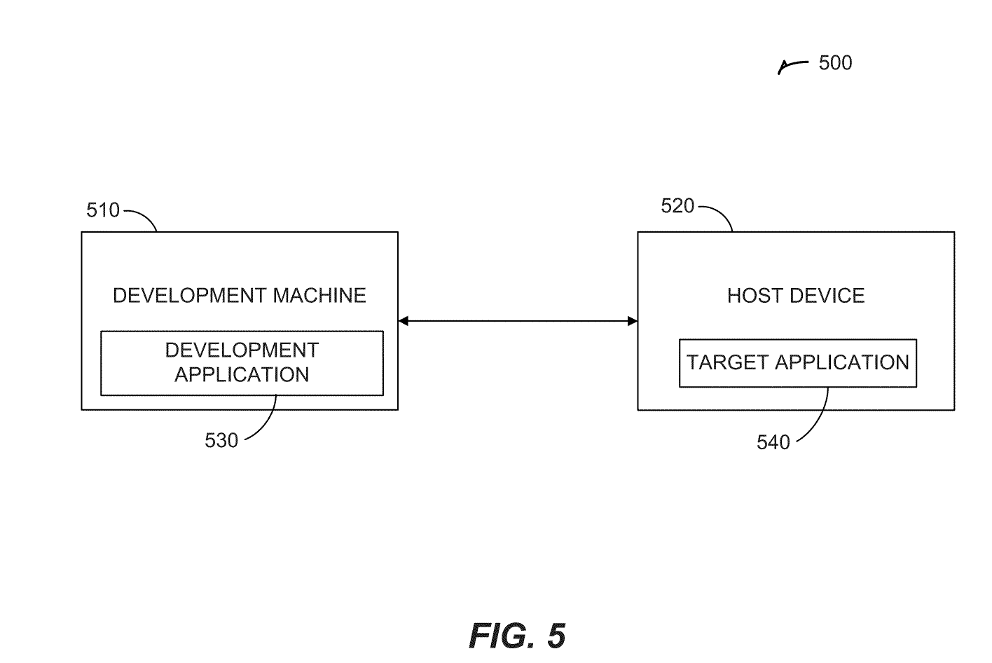

FIG. 2E includes a boundary indicator 240, that indicates the limit of a display area of an individual device. In the depicted example, the boundary indicator 240 includes a dashed parallelogram depicting a region in the canvas where objects in the sixth layer 224 would appear if presented on a corresponding display of the individual device. For example, the display area of a tablet computing device may be larger, or have a different aspect ratio, than a smartphone device. The particular device display represented by the boundary indicator 240 may be selected by a user, or configured in response to a target development setting. For example, the boundary indicator 240 may display a representation of an aspect ratio of a specific target or host device (e.g., host device 520 of FIG. 5) intended to execute the application. The boundary indicator 240 may be positioned around, or on top of, any visible layer. The boundary indicator 240 may be reoriented or changed in response to any change in the orientation or position of the 3D slider 204.

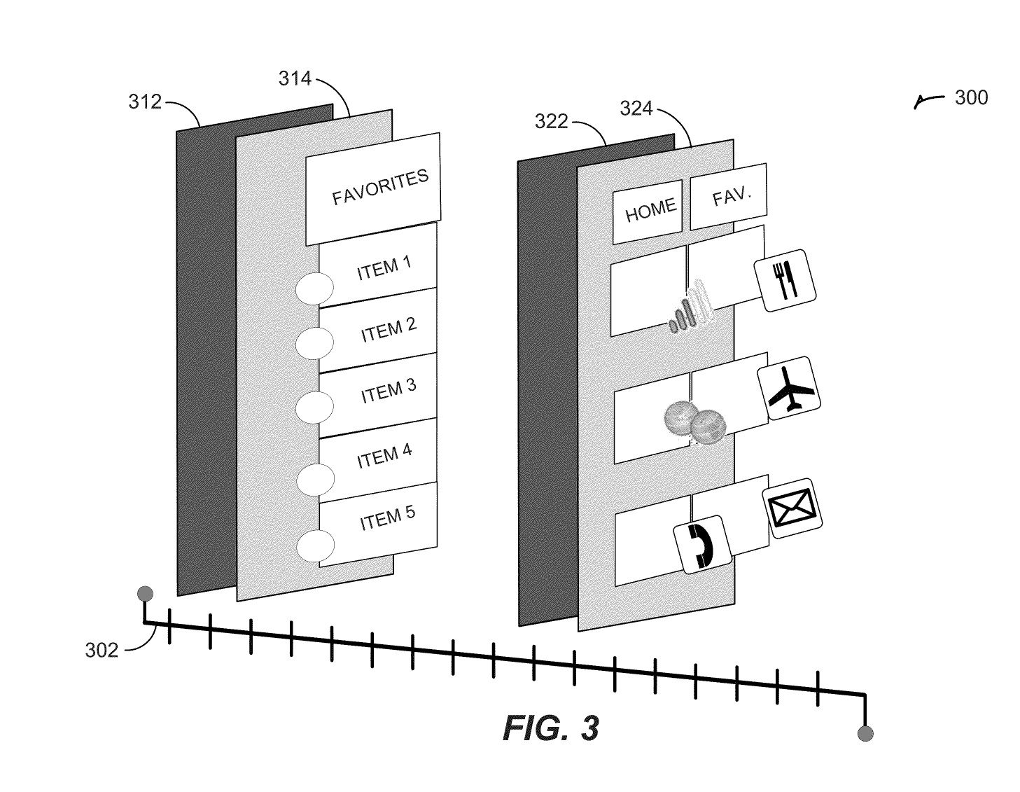

FIG. 3 depicts an example of a 3D slider 302 positioned below the individual layers and objects on a canvas in a 3D mode. The 3D slider 302 may alternatively be positioned above the canvas or at any location in front of the canvas such that an axis 304 of the 3D slider 302 is perpendicular to a plurality of layers disposed in parallel planes on the canvas. The layers 312, 314, 322, and 424 correspond to the layers similarly depicted layers 212, 214, 222 and 224 in FIG. 2A.

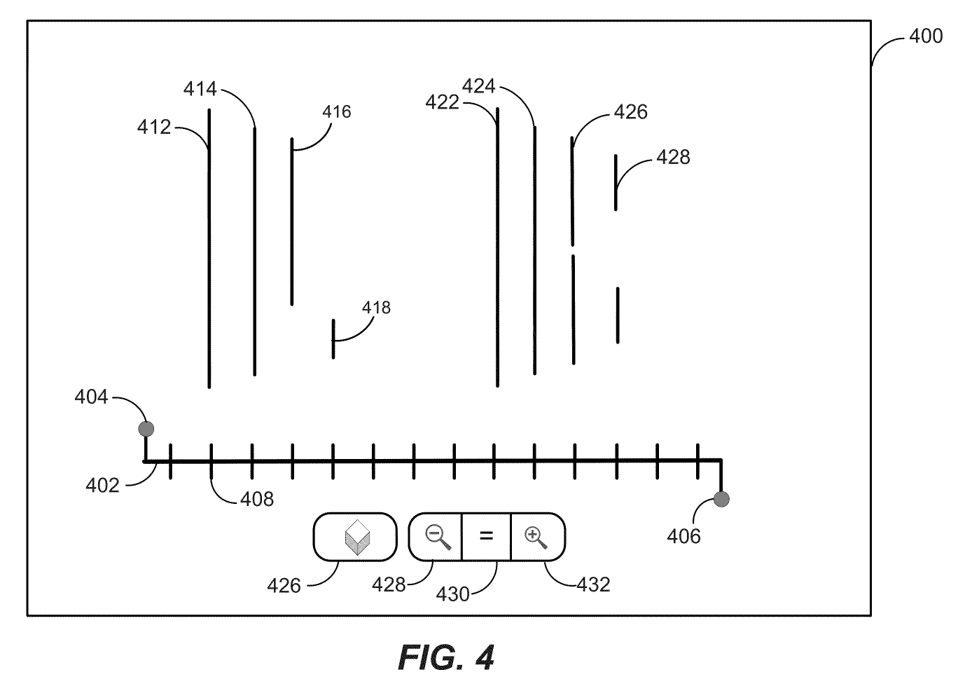

FIG. 4 depicts a block diagram illustrating an example of a 3D graphical user interface 400 in a three-dimensional control mode. An example of a slider 402 positioned below a set of individual layers and objects on a canvas. The slider 402 is oriented such that a first control 404 and a second control 406 are aligned to present a side-view of the canvas. In the depicted example, the layers 412, 414, 422, and 424 correspond to the layers similarly numbered layers 212, 214, 222 and 224 in FIG. 2A. In this configuration the vertical alignment of each object in its respective layer may be displayed.

The 3D graphical user interface 400 may include a camera angle selector 426, that when selected may allow a user to change the viewing angle, e.g., camera angle, depicted by the 3D graphical user interface 400. The 3D graphical user interface 400 may include a view selection tools. For example, a zoom-out tool 428, a full-size view tool 430, and a zoom-in tool 432, may change the number of visible objects, or manipulate the size of the objects displayed in the 3D graphical user interface 400. In an example, when a user has zoomed in on the canvas, only the objects in visible layers of the graphical user interface 400 will be controlled by the slider 402.

FIG. 5 is a network diagram depicting a network 500, within which an example embodiment can be deployed. The network 500 includes a development machine 510 and a host device 520, communicating via a direct connection such as a universal serial bus (“USB”) or Bluetooth connection, or via an indirect connection such as a local-area network (“LAN”) or the Internet. In some example embodiments, the development machine 510 and the host device 520 are the same device. The host device 520 may include a target device that has a different display resolution or display aspect ratio than the development machine 510.

The development machine 510 runs a development application 530. The target application 540 may run on the host device 520. The development application 530 accesses the target application 540 to provide development information to an application developer. For example, the target application 540 may be running on the host device 520. The development application 530 may have access to the source code for the target application 540 and the memory of the host device 520. Based on the source code for the target application 540 and the memory of the host device 520, current values for variables, structures, and classes described in the source code of the target application 540 can be determined. The development application 530 can present these values to the application developer. Among the values that may be accessed by the development application are values corresponding to the user interface of the target application 540.

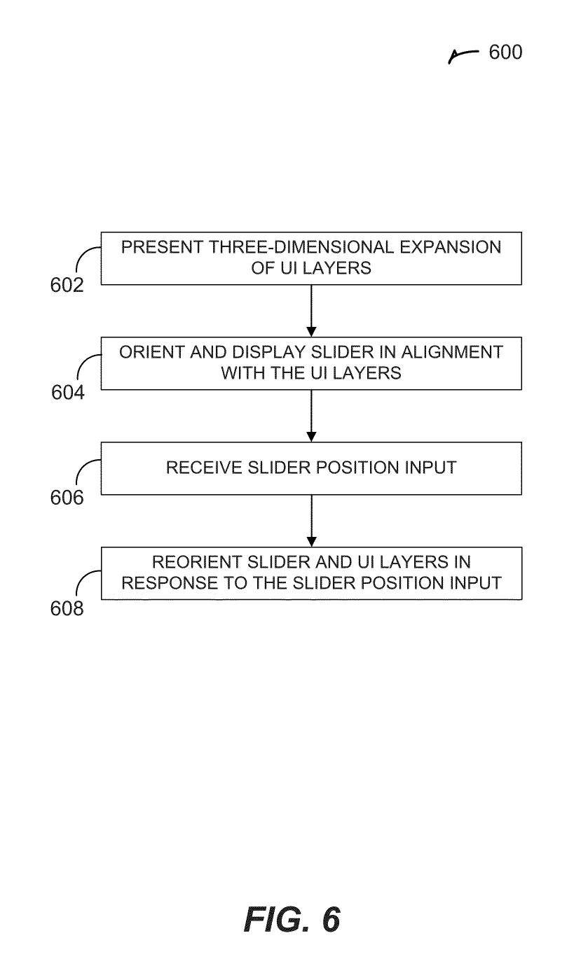

Though arranged serially in the examples of FIGS. 6-8, other examples may reorder the operations, omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

FIG. 6 is a flowchart illustrating operations of a device or apparatus in performing methods of manipulating a three-dimensional display, according to an example. In the example, operations in the method 600 may be performed by the development machine 510 of FIG. 5, using techniques described above with respect to FIGS. 2A-2E. The method 600 includes operations such as presenting a three-dimensional expansion of user-interface (UI) layer at 602, orienting and displaying a slider in alignment with the UI layers at 604, receiving a slider position input at 606, and reorienting the slider and UI layers in response to the slider position input at 608.

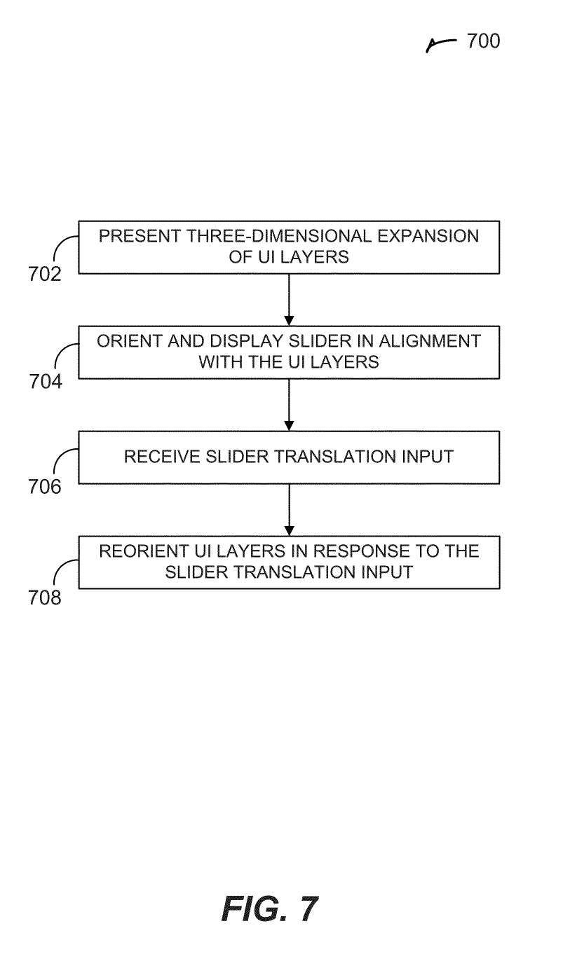

FIG. 7 is a flowchart illustrating operations of a device or apparatus in performing methods of manipulating a three-dimensional display, according to an example. In the example, operations in the method 600 may be performed by the development machine 510 of FIG. 5, using techniques described above with respect to FIGS. 2A-2E. The method 700 includes operations such as presenting a three-dimensional expansion of user-interface (UI) layer at 702, orienting and displaying a slider in alignment with the UI layers at 704, receiving a slider translation input at 706, and reorienting the UI layers in response to the slider translation input at 708.

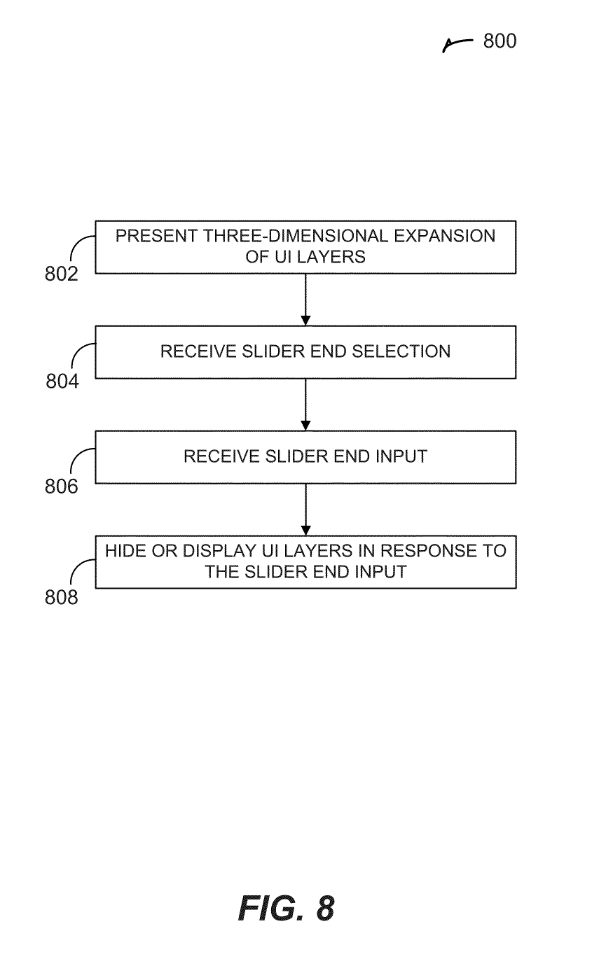

FIG. 8 is a flowchart illustrating operations of a device or apparatus in performing methods of manipulating a three-dimensional display, according to an example. In the example, operations in the method 600 may be performed by the development machine 510 of FIG. 5, using techniques described above with respect to FIGS. 2A-2E. The method 800 includes operations such as presenting a three-dimensional expansion of user-interface (UI) layer at 802, orienting and displaying a slider in alignment with the UI layers at 804, receiving a slider end input at 806, and hiding or displaying UI layers in response to the slider end input at 808.

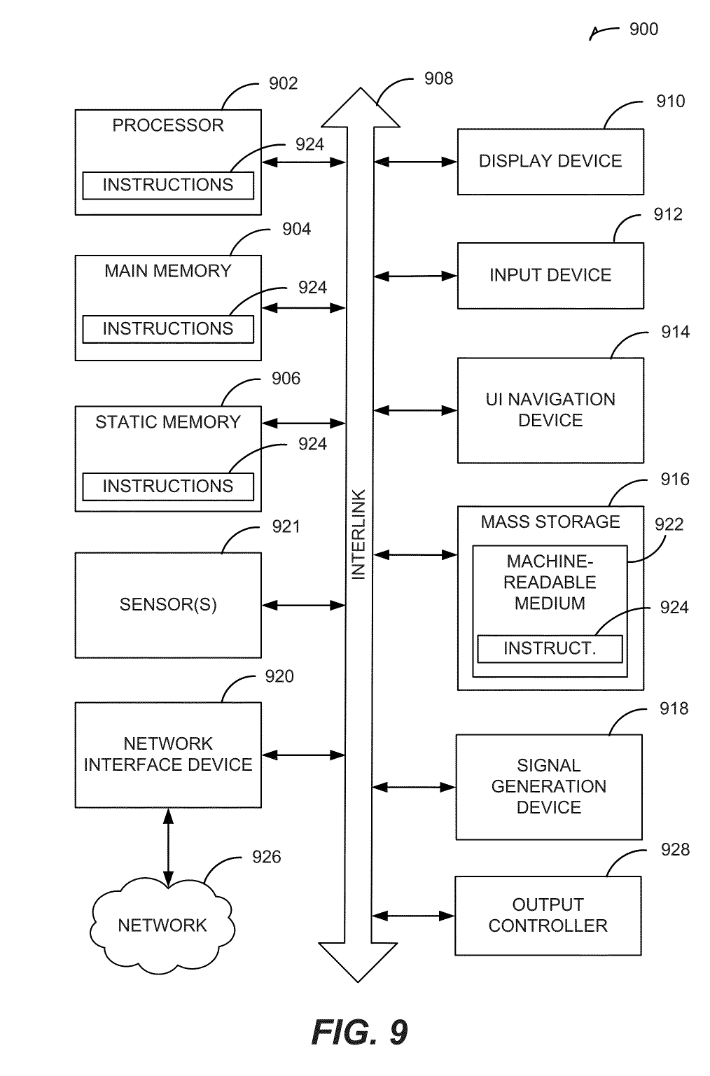

FIG. 9 is a block diagram illustrating an example machine 900 upon which any one or more of the techniques (e.g., methodologies) discussed herein may be performed. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules or components are tangible entities capable of performing specified operations and may be configured or arranged in a certain manner. In an example, circuits may be arranged (e.g., internally or with respect to external entities such as other circuits) in a specified manner as a module or component. In an example, the whole or part of one or more computer systems (e.g., a standalone, client or server computer system) or one or more hardware processors may be configured by firmware or software (e.g., instructions, an application portion, or an application) as a module/component that operates to perform specified operations. In an example, the software may reside (1) on a non-transitory machine-readable medium or (2) in a transmission signal. In an example, the software, when executed by the underlying hardware of the module/component, causes the hardware to perform the specified operations.

Accordingly, the terms “module” and “component” are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules/components are temporarily configured, each of the modules/components need not be instantiated at any one moment in time. For example, where the modules/components comprise a general-purpose hardware processor configured using software, the general-purpose hardware processor may be configured as respective different modules/components at different times. Software may accordingly configure a hardware processor, for example, to constitute a particular module/component at one instance of time and to constitute a different module at a different instance of time.

Machine (e.g., computer system) 900 may include a hardware processor 902 (e.g., a processing unit, a graphics processing unit (GPU), a hardware processor core, or any combination thereof), a main memory 904, and a static memory 906, some or all of which may communicate with each other via a link 908 (e.g., a bus, link, interconnect, or the like). The machine 900 may further include a display device 910, an input device 912 (e.g., a keyboard), and a user interface (UI) navigation device 914 (e.g., a mouse). In an example, the display device 910, input device 912, and UI navigation device 914 may be a touch screen display. The machine 900 may additionally include a mass storage (e.g., drive unit) 916, a signal generation device 918 (e.g., a speaker), a network interface device 920, and one or more sensors 921, such as a global positioning system (GPS) sensor, camera, video recorder, compass, accelerometer, or other sensor. The machine 900 may include an output controller 928, such as a serial (e.g., universal serial bus (USB), parallel, or other wired or wireless (e.g., infrared (IR)) connection to communicate or control one or more peripheral devices (e.g., a printer, card reader, etc.).

The mass storage 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage 916 may constitute machine readable media.

While the machine-readable medium 922 is illustrated as a single medium, the term “machine readable medium” may include a single medium or multiple media (e.g., a centralized or distributed database, and/or associated caches and servers) that configured to store the one or more instructions 924. The term “machine-readable medium” may include any tangible medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

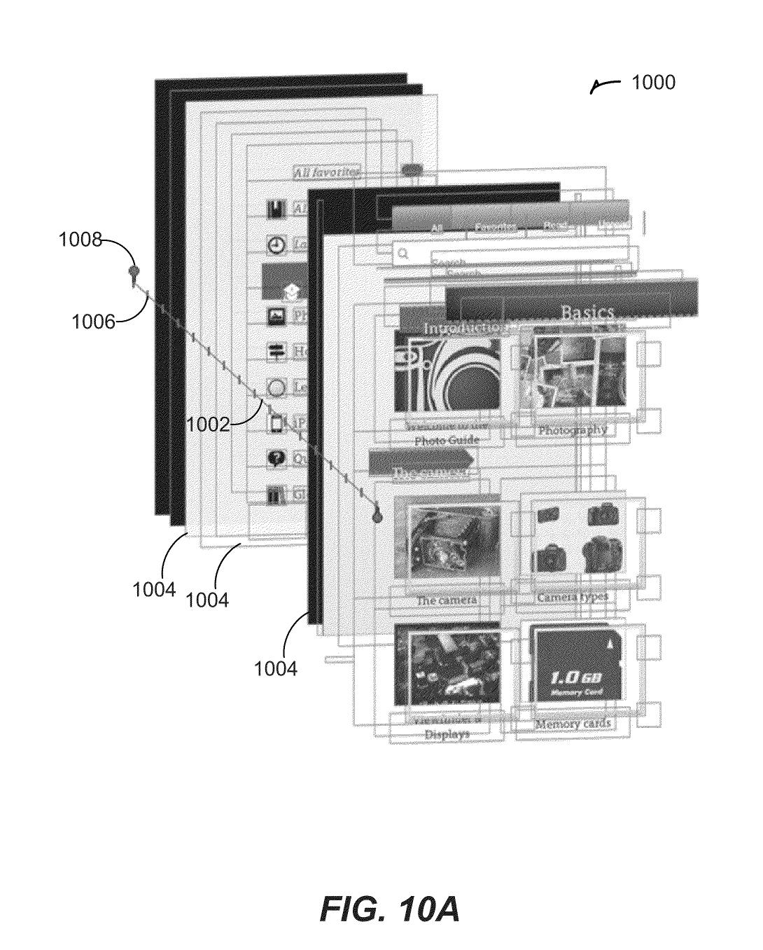

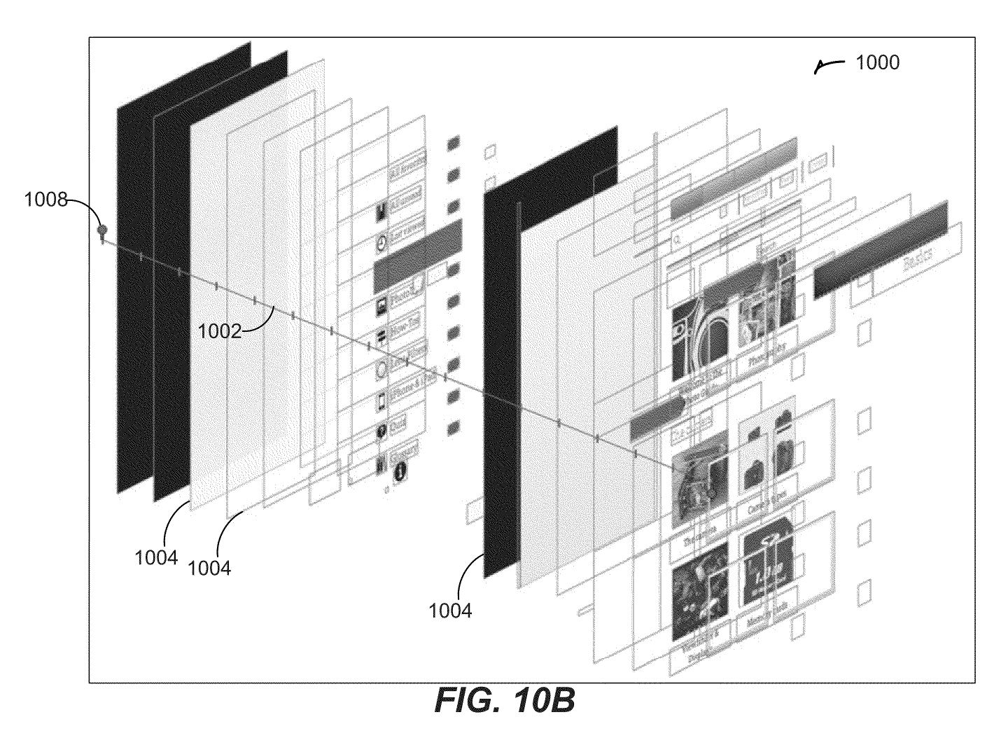

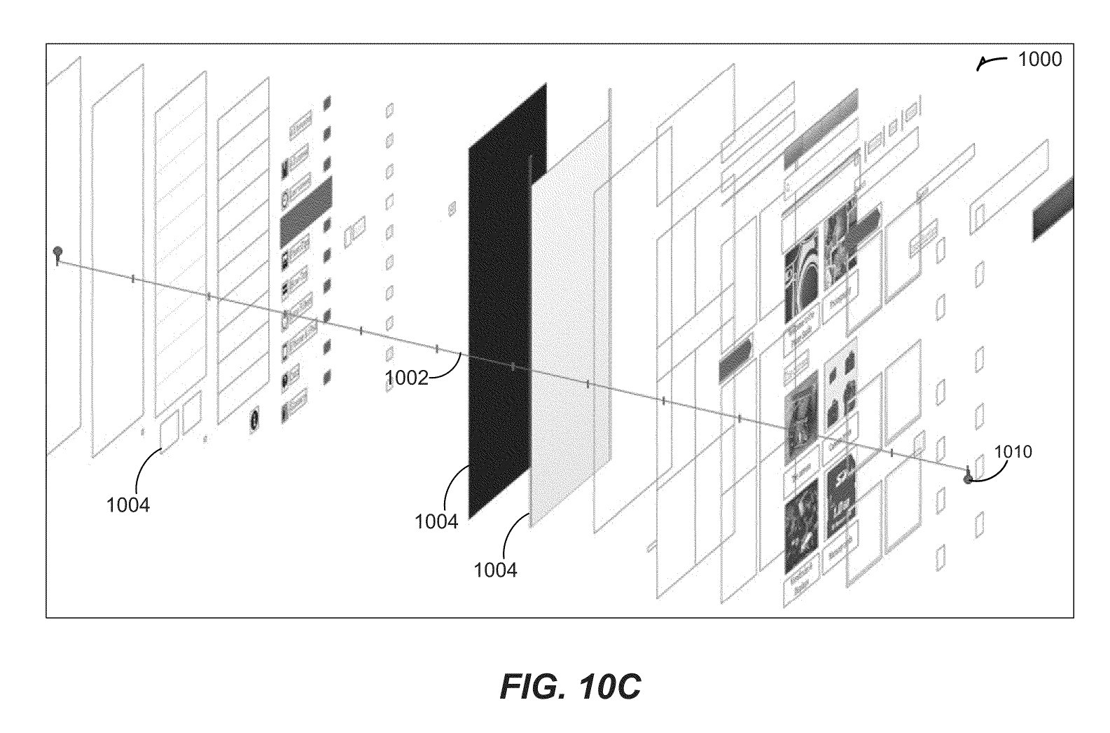

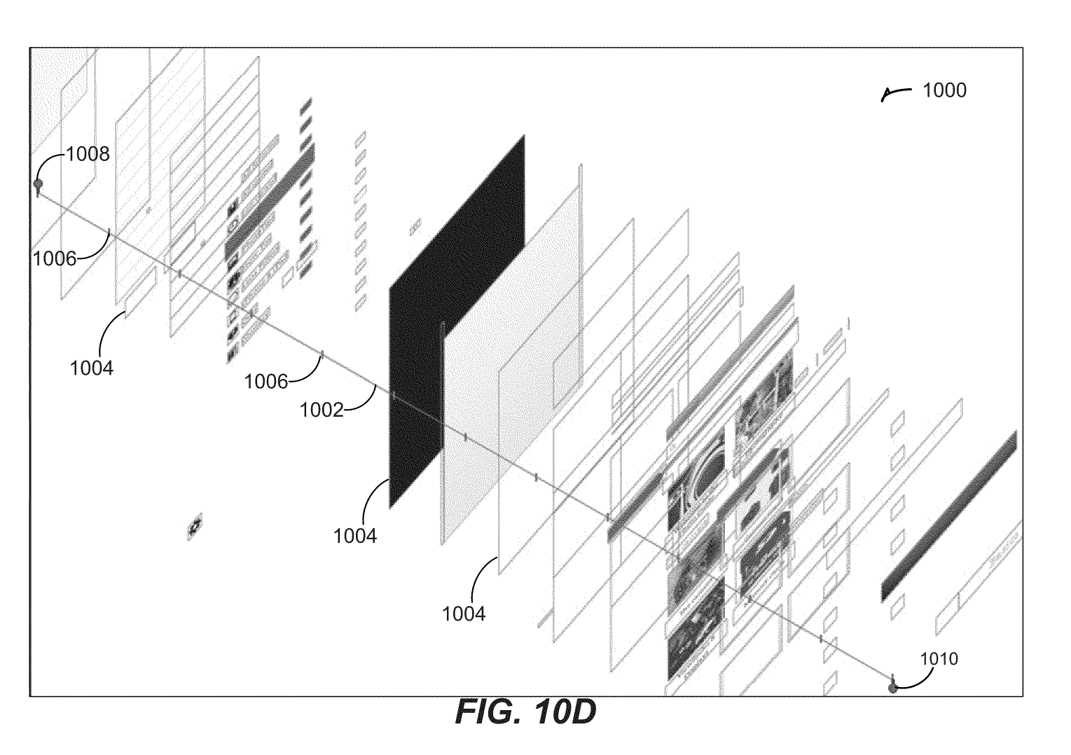

FIGS. 10A through 10D depict block diagrams illustrating four different views of an example of a graphical user interface (GUI) 1000 in a three-dimensional control mode. The GUI 1000 includes a slider 1002 and a plurality of layers 1004 that are aligned. The plurality of layers 1004 may be manipulated by changing the orientation of the slider 1002 or the distance between divisions 1006 disposed on the slider 1002. For example, a spacing input received at a first slider-control 1008 or a second slider-control 1010 may increase or decrease the distance between divisions 1006 and the plurality of layers 1004.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A graphical user interface (GUI), generated for presentation on a device, the GUI comprising:
a slider generated for presentation on a display of the device, the slider including an axis oriented perpendicularly to a plurality of layers presented on the display and arranged as parallel planes, the slider including a plurality of equidistantly spaced indicators, each one of the indicators corresponding to one of the plurality of layers;
at least one object disposed in each one of the plurality of layers;
a first slider-control disposed at a first end of the slider, the first slider control being positionable along the axis; and
a second slider-control disposed at a second end of the slider, the second slider control being positionable along the axis of the slider, the second end being opposite the first end;
wherein a first position of the first slider-control and a second position of the second slider-control along the axis determine which of the plurality of layers are generated for presentation on the display.

2. The GUI of claim 1, wherein a position input received at the first slider-control or the second slider-control reorients the slider, the plurality of layers, and the object disposed in each one of the plurality of parallel layers.

3. The GUI of claim 1, wherein a spacing input received at the first slider-control, the second slider-control, or one of the indicators, along the axis changes a distance between each one of the plurality of parallel layers and the indicators, the change in the distance corresponding to a magnitude of the translation input.

4. The GUI of claim 1, wherein a first subset of layers within the plurality of layers corresponding to indicators on the axis between the first slider-control and the second slider-control are visible within the presentation generated for display.

5. The GUI of claim 4, wherein a second subset of layers within the plurality of layers corresponding to indicators on the axis outside the first slider-control and the second slider-control are not visible within the presentation generated for display.

6. The GUI of claim 1, wherein the slider is disposed in front of the plurality of layers on the display.

7. The GUI of claim 1, wherein the slider is disposed below the plurality of layers on the display.

8. The GUI of claim 1, wherein the first slider-control includes a first indicator and the second slider-control includes a second indicator, the first indicator and the second indicator being configured to display a selection status condition, the selection status condition indicating that the first slider-control or the second slider-control is selected to receive either a position input or a translation input.

9. An apparatus, including a processor and memory, configured to generate a three-dimensional user interface for presentation on a display coupled to the processor, the three-dimensional user interface comprising:
a slider generated for presentation on the display of the device, the slider including an axis oriented perpendicularly to a plurality of layers presented on the display and arranged as parallel planes, the slider including a plurality of equidistantly spaced indicators, each one of the indicators corresponding to one of the plurality of layers;
at least one object disposed in each one of the plurality of layers;
a first slider-control disposed at a first end of the slider, the first slider control being positionable along the axis of the slider; and
a second slider-control disposed at a second end of the slider, the second slider control being positionable along the axis of the slider, the second end being opposite the first end;
wherein a first position of the first slider-control and a second position of the second slider-control along the axis of the slider determine which of the plurality of layers are generated for presentation on the display.

10. The apparatus of claim 9, further comprising an input device, the input device configured to receive a position input at the first slider-control or the second slider-control that reorients the slider, the plurality of layers, and the object disposed in each one of the plurality of parallel layers.

11. The apparatus of claim 10, wherein the input devices is configured to receive a spacing input at the first slider-control or the second slider-control along the axis of the slider that changes a distance between each one of the plurality of layers and the indicators, the change in the distance corresponding to a magnitude of the translation input.

12. The apparatus of claim 9, wherein a first subset of layers within the plurality of layers corresponding to indicators on the axis between the first slider-control and the second slider-control are visible within the presentation generated for display; and a second subset of layers within the plurality of layers corresponding to indicators on the axis outside the first slider-control and the second slider-control are not visible within the presentation generated for display.

13. The apparatus of claim 9, wherein the first slider-control includes a first indicator and the second slider-control includes a second indicator, the first indicator and the second indicator being configured to display a selection status condition, the selection status condition indicating that the first slider-control or the second slider-control is selected to receive either a position input or a translation input.

14. At least one non-transitory machine readable storage medium comprising a plurality of instructions that when executed by a computing device cause the computing device to:
generate a three-dimensional user interface for presentation on a display coupled to the processor, the three-dimensional user interface comprising:
a slider generated for presentation on the display of the device, the slider including an axis oriented perpendicularly to a plurality of layers presented on the display and arranged as parallel planes, the slider including a plurality of equidistantly spaced indicators, each one of the indicators corresponding to a one of the plurality of layers;
at least one object disposed in each one of the plurality of layers;
a first slider-control disposed at a first end of the slider, the first slider control being positionable along the axis of the slider; and
a second slider-control disposed at a second end of the slider, the second slider control being positionable along the axis of the slider, the second end being opposite the first end;
wherein a first position of the first slider-control and a second position of the second slider-control along the axis of the slider determine which of the plurality of layers are generated for presentation on the display.

15. The at least one non-transitory machine readable medium as recited in claim 14, further comprising instructions that when executed by the computing device cause the computing device to:
receive a position input at the first slider-control or the second slider-control that reorients the slider, the plurality of layers, and the object disposed in each one of the plurality of parallel layers.

16. The at least one non-transitory machine readable medium as recited in claim 14, further comprising instructions that when executed by the computing device cause the computing device to:
receive a spacing input at the first slider-control or the second slider-control along the axis of the slider that changes a distance between each one of the plurality of layers and the indicators, the change in the distance corresponding to a magnitude of the translation input.

17. The at least one non-transitory machine readable medium as recited in claim 14, wherein a first subset of layers within the plurality of layers corresponding to indicators on the axis between the first slider-control and the second slider-control are visible within the presentation generated for display; and a second subset of layers within the plurality of layers corresponding to indicators on the axis outside the first slider-control and the second slider-control are not visible within the presentation generated for display.

18. The at least one non-transitory machine readable medium as recited in claim 14, wherein the first slider-control includes a first indicator and the second slider-control includes a second indicator, the first indicator and the second indicator being configured to display a selection status condition, the selection status condition indicating that the first slider-control or the second slider-control is selected to receive either a position input or a translation input.

19. The at least one non-transitory machine readable medium as recited in claim 14, wherein the slider is disposed in front of the plurality of layers when presented on the display.

20. The at least one non-transitory machine readable medium as recited in claim 14, wherein the slider is disposed below the plurality of layers when presented on the display.
